(19) United States
(12) Patent Application Publication
(10) Pub. No.: US 2026/0127306 A1
(43) Pub. Date: May 7, 2026

(54) SYSTEMS AND METHODS OF FACILITATING SECURE INFERENCING OF A MACHINE LEARNING MODEL

(71) Applicant: Elad Rave, San Francisco, CA (US)

(72) Inventor: Elad Rave, San Francisco, CA (US)

(21) Appl. No.: 18/939,227

(22) Filed: Nov. 6, 2024

(51) Int. Cl. G06F 21/62

(52) U.S. Cl. CPC G06F 21/6218

(57) ABSTRACT

The present disclosure provides the method of facilitating secure inferencing of a machine learning model. Further, the method may include receiving an input data from a client device associated with a client. Further, the method may include analyzing the input data. Further, the method may include receiving a relevant data from a data source device associated with a data source. Further, the receiving of the relevant data may be based on the analysis. Further, the method may include processing the relevant data in accordance with the machine learning model to obtain a processed relevant data. Further, the machine learning model may be immutable. Further, the method may include generating an output data using the machine learning model. Further, the generating of the output data may be based on the processed relevant data and the input data. Further, the method may include transmitting the output data to the client device.

### FIELD OF DISCLOSURE

Generally, the present disclosure relates to the field of data processing. More specifically, the present disclosure relates to methods and systems for facilitating secure inferencing of a machine learning model.

### BACKGROUND

With the increasing reliance on AI models in enterprise applications, it is crucial to ensure the security, privacy, and integrity of these models. Traditional methods often risk information leakage and unauthorized access, compromising both data and model security. The present disclosed system addresses these issues by providing a secure, privacy-preserving, and zero-trust framework for AI model inferencing and management.

### SUMMARY OF DISCLOSURE

This summary is provided to introduce a selection of concepts in a simplified form that are further described below in the Detailed Description. This summary is not intended to identify key features or essential features of the claimed subject matter. Nor is this summary intended to be used to limit the claimed subject matter's scope.

The present disclosure provides the method of facilitating secure inferencing of a machine learning model. Further, the method may include receiving, using the communication device, an input data from a client device associated with a client. Further, the method may include analyzing, using a processing device, the input data. Further, the method may include receiving, using the communication device, a relevant data from a data source device associated with a data source. Further, the receiving of the relevant data may be based on the analysis. Further, the method may include processing, using the processing device, the relevant data in accordance with the machine learning model to obtain a processed relevant data. Further, the machine learning model may be immutable. Further, the method may include generating, using the processing device, an output data using the machine learning model. Further, the generating of the output data may be based on the processed relevant data and the input data. Further, the method may include transmitting, using the communication device, the output data to the client device.

The present disclosure provides the system of facilitating secure inferencing of a machine learning model. Further, the system may include a communication device. Further, the communication device may be configured to receive an input data from a client device associated with a client. Further, the communication device may be configured to receive a relevant data from a data source device associated with a data source. Further, the receiving of the relevant data may be based on an analysis. Further, the communication device may be configured to transmit an output data to the client device. Further, the system may include a processing device communicatively coupled with the communication device. Further, the processing device may be configured to analyze the input data. Further, the processing device may be configured to process the relevant data in accordance with the machine learning model to obtain a processed relevant data. Further, the machine learning model may be immutable. Further, the processing device may be configured to generate the output data using the machine learning model. Further, the generating of the output data may be based on the processed relevant data and the input data.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTIONS OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform 100 consistent with various embodiments of the present disclosure.

FIG. 2 is a block diagram of a computing device 200 for implementing the methods disclosed herein, in accordance with some embodiments.

FIG. 3 illustrates a flowchart of a method 300 of facilitating secure inferencing of a machine learning model, in accordance with some embodiments.

FIG. 4 illustrates a flowchart of a method 400 of facilitating secure inferencing of a machine learning model including integrating, using the processing device 604, an adapter into at least one layer of the machine learning model, in accordance with some embodiments.

FIG. 5 illustrates a flowchart of a method 500 of facilitating secure inferencing of a machine learning model including authenticating, using the processing device 604, a client device, in accordance with some embodiments.

FIG. 6 illustrates a block diagram of a system 600 of facilitating secure inferencing of a machine learning model, in accordance with some embodiments.

FIG. 7 is a block diagram of a system 700 for facilitating secure inference of a machine learning model, in accordance with some embodiments.

FIG. 8 is a flow diagram of a Data Fetching Unit 702 facilitating fetching data from a Data Source 712, in accordance with some embodiments.

FIG. 9 is a flow diagram of a Data Processing Unit 704 facilitating processing of a fetched data, in accordance with some embodiments.

FIG. 10 is a flow diagram of an Inferencing Unit 708 facilitating generation of a result data, in accordance with some embodiments.

FIG. 11 is a flow diagram of a Data Management Unit 710 facilitating performing of an action associated with the processed data, in accordance with some embodiments.

### DETAILED DESCRIPTION OF DISCLOSURE

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denote “at least one,” but do not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of the disclosed use cases, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor, and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server, etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface, etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database, and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled, and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal, or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera, and so on. Likewise, the one or more steps may include receiving, using the communication device, the one or more embodied characteristics from one or more biometric sensors.

Further, one or more steps of the method may be automatically initiated, maintained, and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device, etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performances of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices.

Another objective may be to restrict a location of one or more of an input data, an output data and any intermediate data there between corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

### Overview

The present disclosed system relates to a system for enterprise-grade AI model inferencing and management. The system ensures secure, privacy-preserving, and zero-trust access to AI models, preventing information leakage and model drifting. The system achieves this by hosting models as read-only and dynamically integrating processed data specific to each usage instance.

The disclosed system allows for the usage of AI models in a secure and privacy-preserving manner, preventing information leakage and model drifting. The disclosed system operates under a zero-trust paradigm, ensuring that users/services may only access information they are privileged to.

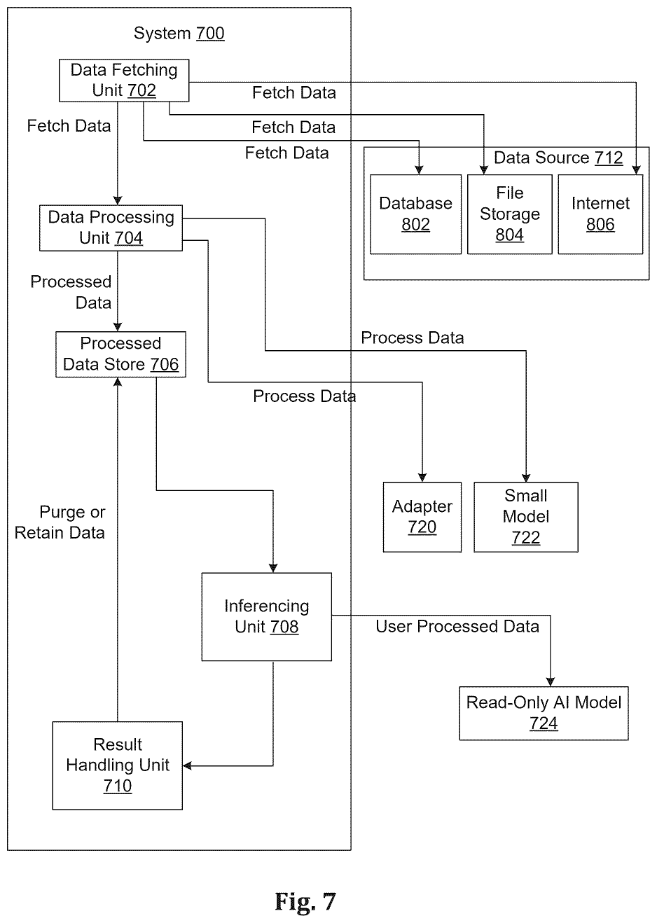

FIG. 7 is a block diagram of a system 700 for facilitating secure inference of a machine learning model, in accordance with some embodiments.

The system 700 may include a data fetching unit 702, a data processing unit 704, a processed data store 706, an inferencing unit 708, and a result handling unit 710. Further, the data fetching unit 702 fetches data from a data source 712. Further, the fetched data may be processed by the data processing unit 704 using one or more of an adapter 720 and a small model 722. Further, the processed data may be stored in the processed store 706. Further, the inferencing unit 708 may combine a read-only AI model 724 and the processed data store in processed data store 706 to generate an output. Further, the result handling unit 710 also referred as a data management unit 710 may be configured to retain the processed data or purge the processed data.

System Overview: The system 700 comprises the following key components: 1. Model Hosting (Read-Only) 724: The AI model is hosted as a read-only entity, ensuring that the base model remains unchanged and secure; 2. Data Fetching Unit 702: When a usage instance requires the AI model, data is fetched from relevant sources such as databases, file storage, or the Internet; 3. Data Processing Unit 704: The fetched data is processed to fit the specific requirements of the AI model. The processing may involve adapters 720, small models 722, or other methods 902 to adjust the original model weights and balances; 4. Processed Data Store 706: The processed data is stored separately and contains only the data relevant to the specific usage instance; 5. Inferencing Unit 708: During inferencing, the system uses the original model and applies the processed data to it, effectively simulating a retrained model for that instance; 6. Result Handling Unit 710: The processed data may be purged or saved for future use, ensuring that only privileged data is retained.

Sequence of Operations involves the following steps: 1.Data Fetching:

Relevant data is fetched from authorized data sources; 2.Data Processing: The fetched data is processed to fit the AI model, using methods such as adapters or small model; 3.Data Storage: The processed data is stored in a separate, secure data store, accessible only by authorized users; 4.Inferencing: The inferencing process combines the original model with the processed data, executing the AI tasks as if the model were retrained; 5.Result Handling: After inferencing, the processed data may be either purged or retained based on user privileges.

Key Features comprise: 1. Zero-Trust Security: Ensures that users/services may only access information they are privileged to; 2. Privacy-Preserving: Prevents information leakage between usage instances; 3. No Model Drifting: Maintains the integrity of the original AI model by hosting the AI model as read-only; 4. Flexible Data Processing: Adapts the original model to new data dynamically, allowing for efficient inferencing.

The disclosed system described is designed to provide a secure and privacy-preserving environment for enterprise-grade AI model inferencing and management. The disclosed system ensures that the AI models remain unaffected by external influences and prevent information leakage between usage instances. By hosting the AI model as read-only and integrating dynamically processed data, the system prevents model drifting and maintains data integrity.

Model Hosting (Read-Only): The core AI model is hosted in a secure environment as a read-only entity. This ensures the model's weights and parameters cannot be altered, maintaining its integrity. The read-only nature of the model is crucial for preventing unauthorized modifications and ensuring consistent performance across different usage instances.

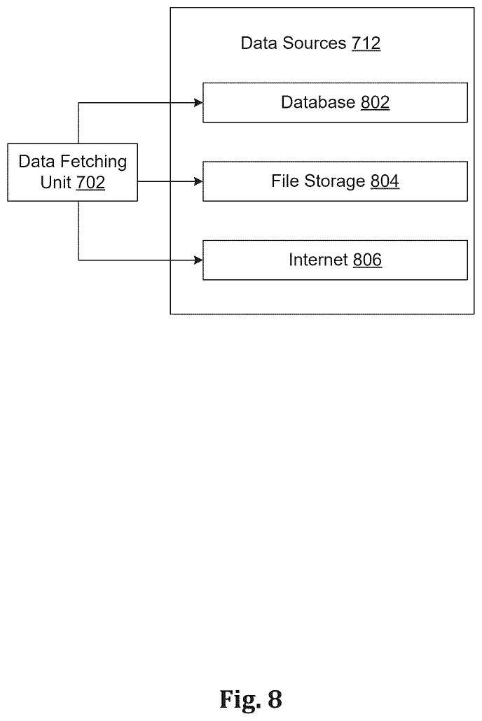

FIG. 8 is a flow diagram of the Data Fetching Unit 702 facilitating fetching data from the Data Source 712, in accordance with some embodiments.

The Data Fetching Unit 702 is responsible for retrieving data from various authorized sources. These sources include, but are not limited to: 1. Databases 802: Structured data stored in relational or NoSQL databases; 2. File Storage 804: Unstructured data such as documents, images, and videos stored in file systems; 3. Internet 806: Data from APIs, web services, or publicly available resources.

The Data fetching unit 702 ensures that only relevant and authorized data is fetched, adhering to security and privacy policies.

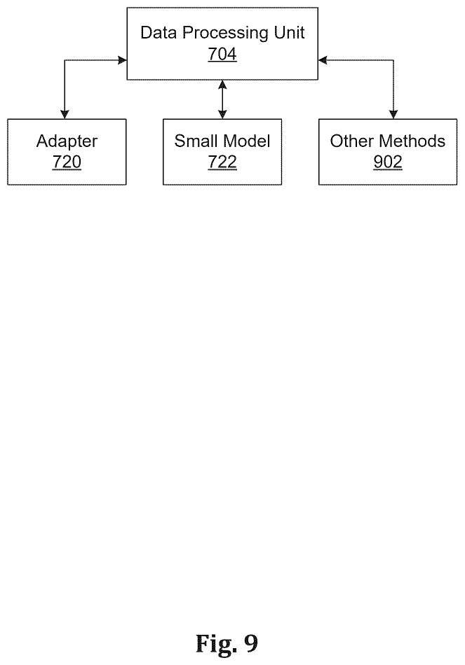

FIG. 9 is a flow diagram of the Data Processing Unit 704 facilitating processing of a fetched data, in accordance with some embodiments.

Data Processing Unit 704: Adapts the fetched data to fit the AI model's requirements. This involves several steps: 1. Adapters 720: Specialized components that transform the data into a format compatible with the AI model. 2. Small Models 722: Auxiliary models that preprocess the data, adjusting the data for compatibility with the primary AI model. 3. Other Methods 902: Any additional techniques required to modify the data appropriately.

The processed data is tailored to ensure effective use of the processed data by the AI model during inferencing.

Processed Data Store 706: The processed data store is a secure repository for storing the adapted data. The processed data is isolated to ensure that: 1. Privacy is maintained: Only data relevant to the specific usage instance is stored; 2. Security is upheld: Access to the processed data is restricted to authorized users and services; 3. Scalability is supported: The storage system is designed to handle large volumes of processed data efficiently.

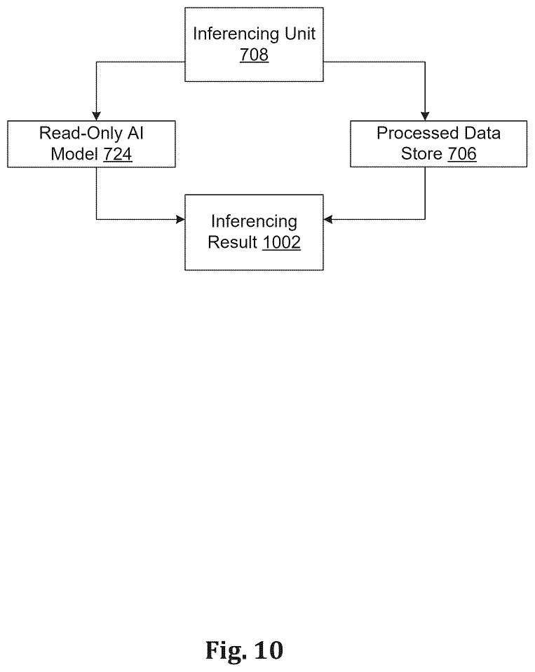

FIG. 10 is a flow diagram of the Inferencing Unit 708 facilitating generation of a result data, in accordance with some embodiments.

FIG. 10 illustrates the inferencing Unit 708 combining the read-only AI model 724 with the processed data stored in the Processed Data Store 706 to execute AI tasks. This process involves: 1. Applying Processed Data: Integrating the processed data stored in the Processed Data store 706 with the read-only AI model 724 in a way that simulates a retrained model; 2. Executing AI Tasks: Running the inferencing process using the combined data and model to generate an inferencing result 1002; 3.Ensuring Integrity: Maintaining the integrity of the read-only model throughout the inferencing process.

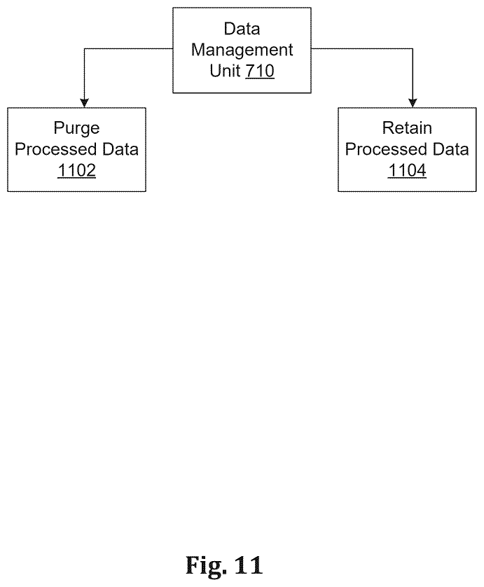

FIG. 11 is a flow diagram of a Data Management Unit 710 facilitating performing of an action associated with the processed data, in accordance with some embodiments.

FIG. 11 illustrates the Data Management Unit 710 deciding whether to purge or retain the processed data based on user privileges post inference. This involves: 1. Purging Processed Data 1102: Securely delete the processed data to prevent unauthorized access or information leakage; 2. Retaining Processed Data 1104: Storing the processed data for future use, ensuring the processed data remains accessible only to authorized users.

Zero-Trust Security Framework: The system is built on a zero-trust security framework, which means: 1. No Implicit Trust: Every access request is thoroughly verified, regardless of its origin; 2. Least Privilege Access: Users and services have access only to the data and resources necessary for their functions; 3. Continuous Monitoring: Ongoing assessment of access patterns and behaviors to detect and respond to anomalies.

Privacy-Preserving Mechanisms: The system includes multiple privacy-preserving mechanisms such as: 1. Isolation of Processed Data: Ensuring processed data is kept separate from the base model and other data stores; 2. User-Specific Data Handling: Only data relevant to the specific user or service is processed and used for inferencing; 3. Data Minimization: Limiting the amount of data processed and stored to what is strictly necessary.

No Model Drifting: By hosting the AI model as read-only, the system prevents model drifting, ensuring: 1. Consistency: The base model remains unchanged, providing consistent performance; 2. Integrity: The model's weights and parameters are not altered, maintaining its original training state.

Flexible Data Processing: The system's data processing capabilities allow it to adapt dynamically to various data types and sources, supporting: 1. Multiple Formats: Processing structured, unstructured, and semi-structured data; 2. Various Methods: Utilizing adapters, small models, and other techniques to ensure compatibility with the AI model; 3. Scalability: Efficiently handling large volumes of data without compromising performance.

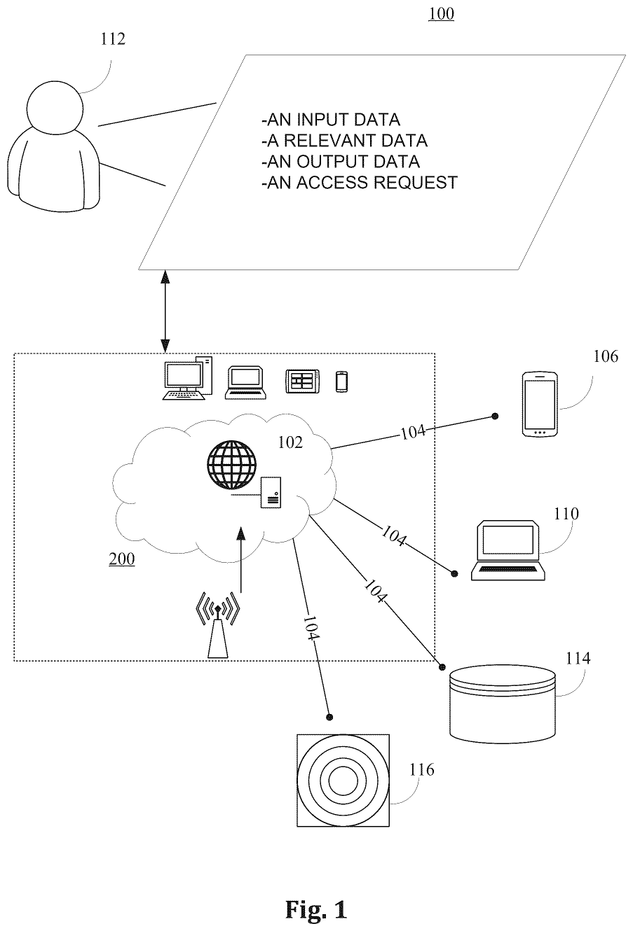

FIG. 1 is an illustration of an online platform 100 consistent with various embodiments of the present disclosure. By way of non-limiting example, the online platform 100 may be hosted on a centralized server 102, such as, for example, a cloud computing service. The centralized server 102 may communicate with other network entities, such as, for example, a mobile device 106 (such as a smartphone, a laptop, a tablet computer, etc.), other electronic devices 110 (such as desktop computers, server computers, etc.), databases 114, and sensors 116 over a communication network 104, such as, but not limited to the Internet. Further, users of the online platform 100 may include relevant parties such as, but not limited to, end-users, administrators, service providers, service consumers, and so on. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 200.

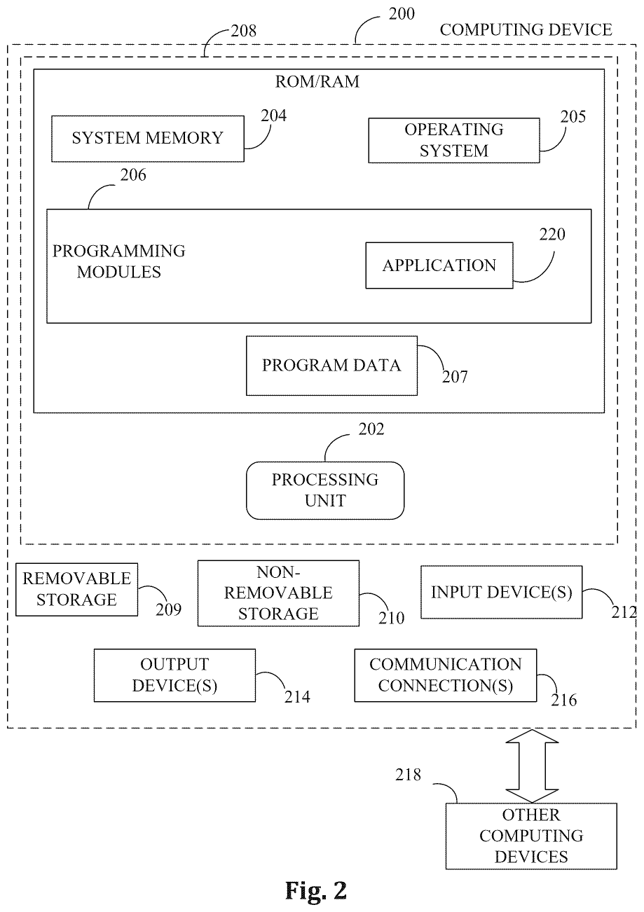

With reference to FIG. 2, a system consistent with an embodiment of the disclosure may include a computing device or cloud service, such as computing device 200. In a basic configuration, computing device 200 may include at least one processing unit 202 and a system memory 204. Depending on the configuration and type of computing device, system memory 204 may comprise, but is not limited to, volatile (e.g. random-access memory (RAM)), non-volatile (e.g. read-only memory (ROM)), flash memory, or any combination. System memory 204 may include operating system 205, one or more programming modules 206, and may include a program data 207. Operating system 205, for example, may be suitable for controlling computing device 200's operation. In one embodiment, programming modules 206 may include image-processing module, machine learning module. Furthermore, embodiments of the disclosure may be practiced in conjunction with a graphics library, other operating systems, or any other application program and is not limited to any particular application or system. This basic configuration is illustrated in FIG. 2 by those components within a dashed line 208.

Computing device 200 may have additional features or functionality. For example, computing device 200 may also include additional data storage devices (removable and/or non-removable) such as, for example, magnetic disks, optical disks, or tape. Such additional storage is illustrated in FIG. 2 by a removable storage 209 and a non-removable storage 210. Computer storage media may include volatile and non-volatile, removable, and non-removable media implemented in any method or technology for storage of information, such as computer-readable instructions, data structures, program modules, or other data. System memory 204, removable storage 209, and non-removable storage 210 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD), or other optical storage, magnetic cassettes, magnetic tape, magnetic disk storage or other magnetic storage devices, or any other medium which can be used to store information and which can be accessed by computing device 200. Any such computer storage media may be part of device 200. Computing device 200 may also have input device(s) 212 such as a keyboard, a mouse, a pen, a sound input device, a touch input device, a location sensor, a camera, a biometric sensor, etc. Output device(s) 214 such as a display, speakers, a printer, etc. may also be included. The aforementioned devices are examples and others may be used.

Computing device 200 may also contain a communication connection 216 that may allow device 200 to communicate with other computing devices 218, such as over a network in a distributed computing environment, for example, an intranet or the Internet. Communication connection 216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 204, including operating system 205. While executing on processing unit 202, programming modules 206 (e.g., application 220 such as a media player) may perform processes including, for example, one or more stages of methods, algorithms, systems, applications, servers, databases as described above. The aforementioned process is an example, and processing unit 202 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods'stages may be modified in any manner, including by reordering stages and/or inserting or deleting stages, without departing from the disclosure.

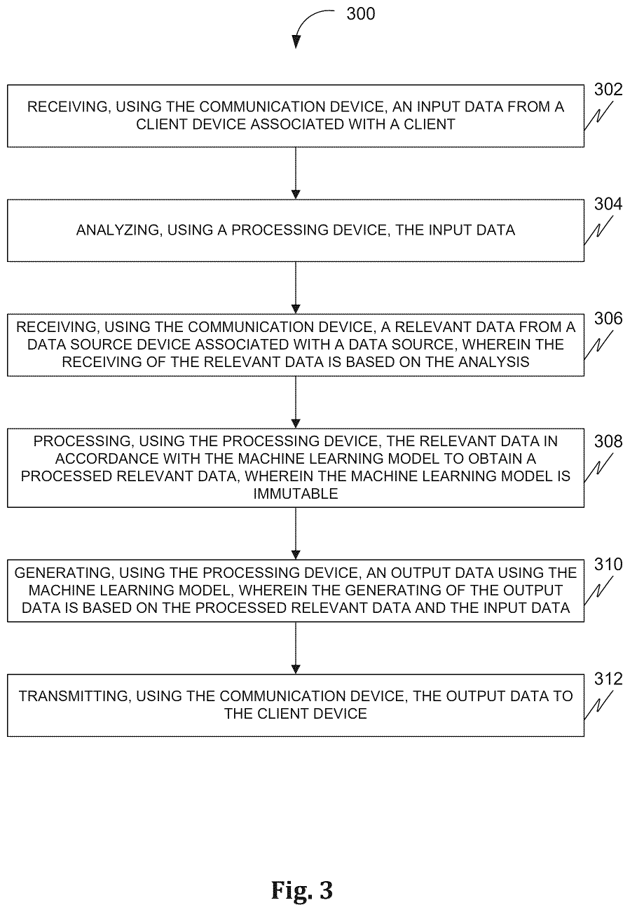

FIG. 3 illustrates a flowchart of a method 300 of facilitating secure inferencing of a machine learning model, in accordance with some embodiments.

In some embodiments, secure inferencing includes one or more of prevention of a data leakage, and prevention of a model drift. In some embodiments, inferencing of a machine learning includes generating a real world output from the machine learning model based on a training of the machine learning model. In some embodiments, the securing of the interference may be facilitated by a zero-trust access to the machine learning model, the processed relevant data, and the relevant data. In some embodiments, the zero-trust access includes verifying one or more of a user and a user device before granting access to the machine learning model.

In some embodiments, the machine learning model includes a machine learning algorithm, and one or more of a parameter associated with the machine learning algorithm, a bias associated with the machine learning algorithm, and a weight associated with the machine learning algorithm. In some embodiments, the machine learning model includes one or more of a supervised learning model, an unsupervised learning model, a semi-supervised learning, and a reinforcement learning model.

In some embodiments, the machine learning model includes an enterprise-grade AI-model. In some embodiments, the machine learning model may be pre trained. In some embodiments, the machine learning model includes a set of instruction. Further, execution of the set of instruction by a processing device 604 facilitates a pattern recognition used to one or more of a decision making, a prediction making, and a sample generation.

Accordingly, the method 300 may include a step 302 of receiving, using the communication device 602, an input data from a client device associated with a client.

In some embodiments, the communication device 602 includes an electronic device which may be configured to one or more of transmit and receive a data. In some embodiments, the one or more of transmit and receive of the data may be wireless. In some embodiments, the input data includes one or more of a text prompt, an image data, an audio data, and a text data.

In some embodiments, the client device includes one or more of a smart device, a personal computer and a server.

Further, the method 300 may include a step 304 of analyzing, using a processing device 604, the input data.

In some embodiments, the analysis of the input data may be based on second machine learning model. In some embodiments, the second machine learning model includes a natural language processing unit.

Further, the method 300 may include a step 306 of receiving, using the communication device 602, a relevant data from a data source device associated with a data source. Further, the receiving of the relevant data may be based on the analysis.

In some embodiments, the data source includes one or more of a database, a file storage, and a network of devices.

In some embodiments, the data source device includes one or more of a computer, a server, and a cloud computing device. In some embodiments, the data source includes a database which may be configured to store a structured data in one or more of a relational or NoSQL databases. In some embodiments, the data source includes a file storage device which may be configured to store an unstructured data comprising one or more of a document data, an image data, and a video data. In some embodiments, the data source includes one or more of a network of devices connected over internet. Further, the relevant data may be retrieved using one or more of an API, a web service and a query associated with a publicly available resource.

Further, the method 300 may include a step 308 of processing, using the processing device 604, the relevant data in accordance with the machine learning model to obtain a processed relevant data.

In some embodiments, the processing of the relevant data facilitates adapting of the relevant data to a requirement of the machine learning model.

In some embodiments, the processing of the relevant data includes altering the relevant data using an auxiliary machine learning model which may be configured to alter the relevant data to generate the processed relevant data.

In some embodiments, the processing of the relevant data includes altering the relevant data using an adapter which may be configured to alter the relevant data to generate the processed relevant data based on the machine learning model. In some embodiments, the adapter includes a specialized component which may be configured to generate the processed relevant data by transforming one or more of the input data and the relevant data into a format compatible with the machine learning model. In some embodiments, the adapter includes a Low Rank Adaption Adapter.

In some embodiments, the adapter includes two or more adapters comprising a first adapter and a second adapter. Further, the relevant data may be input to the first adapter. Further, the processing of the relevant data includes generating, using the first adapter, a first intermediate output data. Further, the first intermediate output data may be input to the second adapter. Further, the processing of the relevant data further includes generating, using the second adapter, a second intermediate output data based on the first intermediate output data. Further, generation of the processed relevant data may be based on the second intermediate output data.

In some embodiments, the adapter includes two or more adapters comprising a first adapter and a second adapter. Further, the relevant data may be input to the first adapter. Further, the processing of the relevant data includes generating, using the first adapter, a first intermediate output data. Further, the relevant data may be input to the second adapter. Further, the processing of the relevant data further includes generating, using the second adapter, a second intermediate output data. Further, generation of the processed relevant data may be based on the first intermediate output data, the second intermediate output data.

Further, the machine learning model may be immutable.

In some embodiments, the machine learning model may be not altered subsequent to the generating of the output data. In some embodiments, the machine learning model may be not altered during the generating of the output data. In some embodiments, the method 300 further includes retrieving, using a read-only storage device, the machine learning model.

In some embodiments, the method 300 further includes retrieving, using a storage device, the machine learning model. Further, the storage device may be configured to forbid any write operation on a storage region associated with the machine learning model.

In some embodiments, the method 300 further includes retrieving, using the storage device, the machine learning model. Further, the method 300 does not include storing, using the storage device, the machine learning model.

Further, in some embodiments, the method 300 further may include a step of receiving, using the communication device 602, the machine learning model from a model repository. Further, in some embodiments, the method 300 further may include a step of storing, using a storage device, the machine learning model. Further, in some embodiments, the method 400 further may include a step of retrieving, using the storage device, the machine learning model into a processor memory comprised in the processing device 604. Further, the storage device may be configured to perform the storing only once and perform the retrieving an indefinite number of times in association with the machine learning model.

In some embodiments, the processing device 604 includes one or more of a GPU comprising a processor memory. Further, the processor memory may be configured to be allow storing of the machine learning model into the processor memory. Further, the processor memory may be configured to disallow any write operation in a memory region associated with the machine learning model.

In some embodiments, one or more of a parameter associated with the machine learning model, a bias associated with the machine learning model, and a weight associated with the machine learning model may be fixed.

Further, the method 300 may include a step 310 of generating, using the processing device 604, an output data using the machine learning model.

Further, the generating of the output data may be based on the processed relevant data and the input data.

In some embodiments, generation of the output data may be based on embedding the relevant data in the input data.

Further, the method 300 may include a step 312 of transmitting, using the communication device 602, the output data to the client device.

In some embodiments, the relevant data includes one or more of a text data, an image data, an audio data, and a vector data.

In some embodiments, the method 300 may further include verifying, using the processing device 604, the data source device based on a data source verification criterion.

In some embodiments, the machine learning model includes a large language model.

In some embodiments, the method 300 may further include storing, using a storage device, the relevant data. Further, the generation of the output data may be based on each of the relevant data stored in the storage device.

In some embodiments, the method 300 may further include receiving, using a read-only storage device, the machine learning model. Further, the processing device 604 includes one or more of a GPU comprising a processor memory. Further, the processor memory may be configured to be allow storing of the machine learning model into the processor memory. Further, the machine learning model includes two or more neural network layers. Further, each of the two or more neural network layers includes a parameter associated with a neural network layer. Further, the generation of the output data may be based of insertion of a new neural network layer within the two or more neural network layers. Further, the new neural network layer includes one or more of a low rank matrix data and a vector data which may be configured to update the parameter of the two or more neural networks. Further, the generation of the output data may be based on the updated parameter of the machine learning model.

In some embodiments, the method 300 may further include transmitting, using the communication device 602, a search query to the data source device. Further, the search query may be generated based on the analysis of the input data. Further, receiving of the relevant data may be based on the search query.

In some embodiments, the method 300 may further include receiving, using a read-only storage device, the machine learning model. Further, the processing device 604 includes one or more of a GPU comprising a processor memory. Further, the processor memory may be configured to be allow storing of the machine learning model into the processor memory. Further, the processing device 604 may be configured to update a parameter associated with the machine learning model stored in the processor memory based on the processed relevant data. Further, the processing device 604 may be configured to generate a parameter delta data associated with the updating of the parameter associated with the machine learning model. Further, the method 300 further includes transmitting, using the communication device 602, the parameter delta data to the client device.

In some embodiments, the method 300 may further include generating, using the processing device 604, a model input data based on the input data and the processed relevant data. Further, the generation of the output data may be based on the model input data using the machine learning model. Further, the generation of the model input data may be based on simulating an output of the machine learning model post retraining using the input data as an input of the machine learning model.

In some embodiments, the input data includes a user identifier. Further, the processed relevant data may be associated with an access level indicator corresponding to the user identifier. Further, the generating of the output data may be based on the access level indicator.

In some embodiments, the method 300 may further include receiving, using the communication device 602, the machine learning model from the client device.

In some embodiments, the method 300 may further include receiving, using the communication device 602, a control data from the client device. Further, the method 300 further comprising storing, using a storage device, the processed relevant data based on the control data.

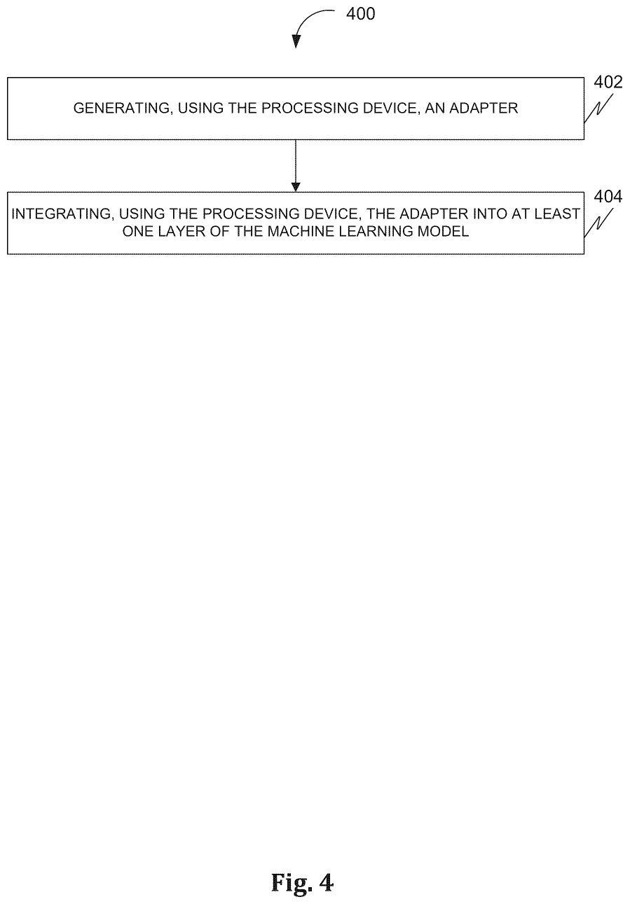

FIG. 4 illustrates a flowchart of a method 400 of facilitating secure inferencing of a machine learning model including integrating, using the processing device 604, an adapter into at least one layer of the machine learning model, in accordance with some embodiments.

Further, in some embodiments, the processing of the relevant data may include a step 402 of generating, using the processing device 604, the adapter. Further, the processing of the relevant data may include a step 404 of integrating, using the processing device 604, the adapter into one or more layers of the machine learning model.

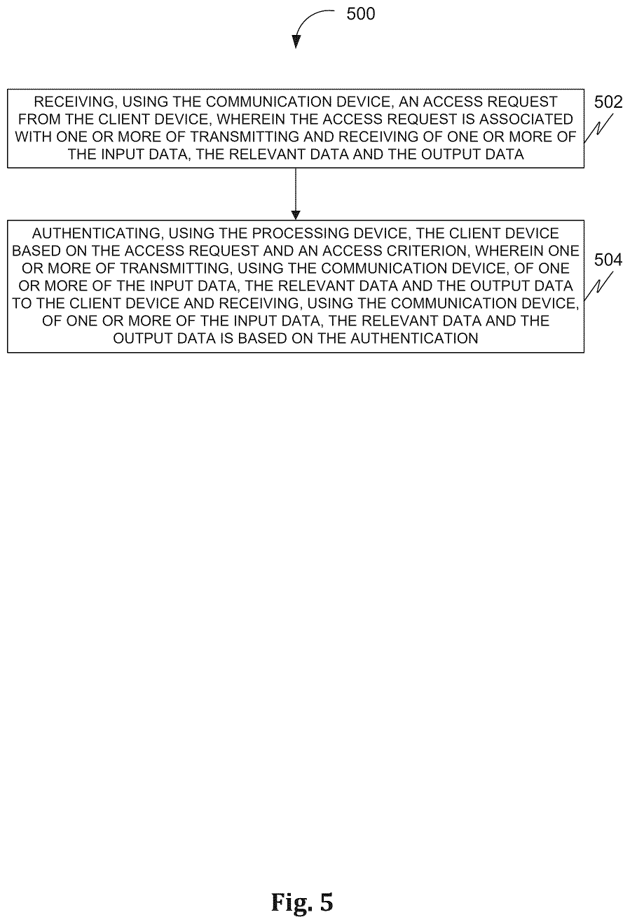

FIG. 5 illustrates a flowchart of a method 500 of facilitating secure inferencing of a machine learning model including authenticating, using the processing device 604, the client device, in accordance with some embodiments.

Further, in some embodiments, the method 500 further may include a step 502 of receiving, using the communication device 602, an access request from the client device. Further, the access request may be associated with one or more of transmitting and receiving of one or more of the input data, the relevant data, and the output data. Further, in some embodiments, the method 500 further may include a step 504 of authenticating, using the processing device 604, the client device based on the access request and an access criterion. Further, one or more of transmitting, using the communication device 602, of one or more of the input data, the relevant data, and the output data to the client device and receiving, using the communication device 602, of one or more of the input data, the relevant data and the output data may be based on the authentication.

Further, in some embodiments, the method 500 further may include a step of analyzing, using the processing device 604, two or more access requests.

Further, in some embodiments, the method 500 further may include a step of generating, using the processing device 604, an anomaly based on the analysis and an alert data corresponding to the anomaly request data.

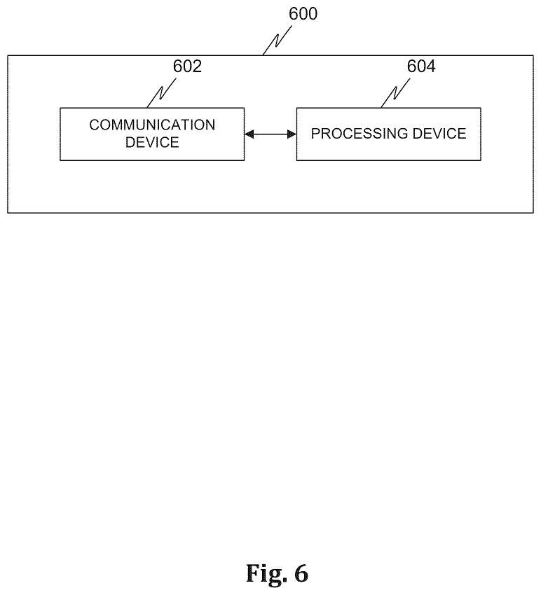

FIG. 6 illustrates a block diagram of a system 600 of facilitating secure inferencing of a machine learning model, in accordance with some embodiments.

Accordingly, the system 600 may include a communication device 602. Further, the communication device 602 may be configured to receive an input data from a client device associated with a client. Further, the communication device 602 may be configured to receive a relevant data from a data source device associated with a data source. Further, the receiving of the relevant data may be based on an analysis. Further, the communication device 602 may be configured to transmit an output data to the client device. Further, the system 600 may include a processing device 604 communicatively coupled with the communication device 602. Further, the processing device 604 may be configured to analyze the input data. Further, the processing device 604 may be configured to process the relevant data in accordance with the machine learning model to obtain a processed relevant data. Further, the machine learning model may be immutable. Further, the processing device 604 may be configured to generate the output data using the machine learning model. Further, the generating of the output data may be based on the processed relevant data and the input data.

In some embodiments, the input data includes a user identifier. Further, the processed relevant data may be associated with an access level indicator corresponding to the user identifier. Further, the generating of the output data may be based on the access level indicator.

Further, in some embodiments, the processing of the relevant data may include configuring the processing device 604 to generate an adapter. Further, the processing of the relevant data may include configuring the processing device 604 to integrate the adapter into one or more layers of the machine learning model.

In some embodiments, the communication device 602 may be further configured to receive an access request from the client device. Further, the access request may be associated with one or more of transmitting and receiving of one or more of the input data, the relevant data and the output data. Further, the processing device 604 may be further configured to authenticate the client device based on the access request and an access criterion. Further, one or more of transmitting, using the communication device 602, of one or more of the input data, the relevant data, and the output data to the client device and receiving, using the communication device 602, of one or more of the input data, the relevant data and the output data may be based on the authentication.

In some embodiments, the processing of the relevant data includes altering the relevant data using an auxiliary machine learning model which may be configured to alter the relevant data to generate the processed relevant data.

In some embodiments, the processing of the relevant data includes altering the relevant data using an adapter which may be configured to alter the relevant data to generate the processed relevant data based on the machine learning model.

In some embodiments, the adapter includes two or more adapters comprising a first adapter and a second adapter. Further, the relevant data may be input to the first adapter. Further, the processing of the relevant data includes generating, using the first adapter, a first intermediate output data. Further, the first intermediate output data may be input to the second adapter. Further, the processing of the relevant data further includes generating, using the second adapter, a second intermediate output data based on the first intermediate output data. Further, generation of the processed relevant data may be based on the second intermediate output data.

In some embodiments, the adapter includes two or more adapters comprising a first adapter and a second adapter. Further, the relevant data may be input to the first adapter. Further, the processing of the relevant data includes generating, using the first adapter, a first intermediate output data. Further, the relevant data may be input to the second adapter. Further, the processing of the relevant data further includes generating, using the second adapter, a second intermediate output data. Further, generation of the processed relevant data may be based on the first intermediate output data, the second intermediate output data.

In some embodiments, the communication device 602 may be further configured to receive the machine learning model from the client device.

In some embodiments, the communication device 602 may be further configured to receive a control data from the client device. Further, the method further comprising storing, using a storage device, the processed relevant data based on the control data.

Although the invention has been explained in relation to its preferred embodiment, it is to be understood that many other possible modifications and variations can be made without departing from the spirit and scope of the invention as hereinafter claimed.

### Aspects

1. A system for enterprise-grade AI model inferencing and management, comprising:
   a. A read-only AI model host;
   b. A data fetching module for retrieving data from authorized sources;
   c. A data processing module for adapting the fetched data to fit the AI model;
   d. A processed data store for securely storing the adapted data;
   e. An inferencing module that combines the read-only AI model with the processed data for execution;
   f. A data management module for purging or retaining the processed data based on user privileges.
2. The system of aspect 1, wherein the data processing module utilizes adapters or small models to adjust the original model weights and balances.
3. The system of aspect 1, wherein the processed data store contains only data relevant to the specific usage instance.
4. The system of aspect 1, wherein the inferencing module simulates a retrained model using the read-only AI model and the processed data.
5. The system of aspect 1, wherein the data management module ensures that only privileged data is retained for future use.
6. The system of aspect 1, further comprising a zero-trust framework to ensure that users and services only access information they are privileged to.
7. The system of aspect 1, wherein the read-only AI model host ensures no alteration to the original model, preventing model drifting.
8. The system of aspect 1, wherein the processed data may be stacked for multiple usage instances as long as the data is privileged to the user.
9. The system of aspect 1, further comprising a privacy-preserving mechanism to prevent information leakage between different usage instances.

What is claimed is:

1. A method of facilitating secure inferencing of a machine learning model, the method comprising:
receiving, using the communication device, an input data from a client device associated with a client;
analyzing, using a processing device, the input data;
receiving, using the communication device, a relevant data from a data source device associated with a data source, wherein the receiving of the relevant data is based on the analysis;
processing, using the processing device, the relevant data in accordance with the machine learning model to obtain a processed relevant data, wherein the machine learning model is immutable;
generating, using the processing device, an output data using the machine learning model, wherein the generating of the output data is based on the processed relevant data and the input data; and
transmitting, using the communication device, the output data to the client device.

2. The method of claim 1, wherein the input data comprises a user identifier, wherein the processed relevant data is associated with an access level indicator corresponding to the user identifier, wherein the generating of the output data is based on the access level indicator.

3. The method of claim 1, wherein the processing of the relevant data comprises:
generating, using the processing device, an adapter;
integrating, using the processing device, the adapter into at least one layer of the machine learning model.

4. The method of claim 1 further comprising:
receiving, using the communication device, an access request from the client device, wherein the access request is associated with one or more of transmitting and receiving of one or more of the input data, the relevant data, and the output data;
authenticating, using the processing device, the client device based on the access request and an access criterion, wherein one or more of transmitting, using the communication device, of one or more of the input data, the relevant data, and the output data to the client device and receiving, using the communication device, of one or more of the input data, the relevant data and the output data is based on the authentication.

5. The method of claim 1, wherein the processing of the relevant data comprises altering the relevant data using an auxiliary machine learning model configured to alter the relevant data to generate the processed relevant data.

6. The method of claim 1, wherein the processing of the relevant data comprises altering the relevant data using an adapter configured to alter the relevant data to generate the processed relevant data based on the machine learning model.

7. The method of claim 6, wherein the adapter comprises a plurality of adapters comprising a first adapter and a second adapter, wherein the relevant data is input to the first adapter, wherein the processing of the relevant data comprises generating, using the first adapter, a first intermediate output data, wherein the first intermediate output data is input to the second adapter, wherein the processing of the relevant data further comprises generating, using the second adapter, a second intermediate output data based on the first intermediate output data, wherein generation of the processed relevant data is based on the second intermediate output data.

8. The method of claim 6, wherein the adapter comprises a plurality of adapters comprising a first adapter and a second adapter, wherein the relevant data is input to the first adapter, wherein the processing of the relevant data comprises generating, using the first adapter, a first intermediate output data, wherein the relevant data is input to the second adapter, wherein the processing of the relevant data further comprises generating, using the second adapter, a second intermediate output data, wherein generation of the processed relevant data is based on the first intermediate output data, the second intermediate output data.

9. The method of claim 1 further comprises receiving, using the communication device, the machine learning model from the client device.

10. The method of claim 1 further comprising receiving, using the communication device, a control data from the client device, wherein the method further comprising storing, using a storage device, the processed relevant data based on the control data.

11. A system for facilitating secure inferencing of a machine learning model, the system comprising:
a communication device configured to:
receive an input data from a client device associated with a client;
receive a relevant data from a data source device associated with a data source, wherein the receiving of the relevant data is based on an analysis;
transmit an output data to the client device;
a processing device communicatively coupled with the communication device, wherein the processing device is configured to:
analyze the input data;
process the relevant data in accordance with the machine learning model to obtain a processed relevant data, wherein the machine learning model is immutable; and
generate the output data using the machine learning model, wherein the generating of the output data is based on the processed relevant data and the input data.

12. The system of claim 11, wherein the input data comprises a user identifier, wherein the processed relevant data is associated with an access level indicator corresponding to the user identifier, wherein the generating of the output data is based on the access level indicator.

13. The system of claim 11, wherein the processing of the relevant data comprises configuring the processing device to:
generate an adapter; and
integrate the adapter into at least one layer of the machine learning model.

14. The system of claim 11, wherein the communication device is further configured to receive an access request from the client device, wherein the access request is associated with one or more of transmitting and receiving of one or more of the input data, the relevant data and the output data, wherein the processing device is further configured to authenticate the client device based on the access request and an access criterion, wherein one or more of transmitting, using the communication device, of one or more of the input data, the relevant data and the output data to the client device and receiving, using the communication device, of one or more of the input data, the relevant data and the output data is based on the authentication.

15. The system of claim 11, wherein the processing of the relevant data comprises altering the relevant data using an auxiliary machine learning model configured to alter the relevant data to generate the processed relevant data.

16. The system of claim 11, wherein the processing of the relevant data comprises altering the relevant data using an adapter configured to alter the relevant data to generate the processed relevant data based on the machine learning model.

17. The system of claim 16, wherein the adapter comprises a plurality of adapters comprising a first adapter and a second adapter, wherein the relevant data is input to the first adapter, wherein the processing of the relevant data comprises generating, using the first adapter, a first intermediate output data, wherein the first intermediate output data is input to the second adapter, wherein the processing of the relevant data further comprises generating, using the second adapter, a second intermediate output data based on the first intermediate output data, wherein generation of the processed relevant data is based on the second intermediate output data.

18. The system of claim 16, wherein the adapter comprises a plurality of adapters comprising a first adapter and a second adapter, wherein the relevant data is input to the first adapter, wherein the processing of the relevant data comprises generating, using the first adapter, a first intermediate output data, wherein the relevant data is input to the second adapter, wherein the processing of the relevant data further comprises generating, using the second adapter, a second intermediate output data, wherein generation of the processed relevant data is based on the first intermediate output data, the second intermediate output data.

19. The system of claim 11, wherein the communication device is further configured to receive the machine learning model from the client device.

20. The system of claim 11, wherein the communication device is further configured to receive a control data from the client device, wherein the method further comprising storing, using a storage device, the processed relevant data based on the control data.
